(19) United States
(12) Patent Application Publication
(10) Pub. No.: US 2013/0066968 A1
(43) Pub. Date: Mar. 14, 2013

(54) Extendable information management mechanism for collaborative online assessment, problem solving, and related activities

(71) Applicant: Charles Ziegler, Washington, DC (US)

(72) Inventor: Charles Ziegler, Washington, DC (US)

(21) Appl. No.: 13/594,791

(22) Filed: Aug. 25, 2012

Related U.S. Application Data
(60) Provisional application No. 61/575,673, filed on Aug. 25, 2011.

(51) Int. Cl. G06F 15/16

(52) U.S. Cl. 709/204

(57) ABSTRACT

Online, computer-based systems and mechanisms that facilitate social (and/or community) and content networks are known. Existing online social media and/or social network mechanisms, however, are not generally designed, and/or maximizing their strengths, to solve humanity's problems, such as care and management of Earth's natural resources and human behaviors, in areas such as economics, health, and politics. The embodiment of the inventive concept generally relates to a system and method for managing online information and flow of such information among and between stakeholders (individuals and groups) and other content sources, in a computer-based environment. A goal of the embodiment of the inventive concept is to direct, create, and/or facilitate use of a knowledge sharing and collaborative platform, in the form of a website, websites, and/or online mechanisms, for individual and collective engagement in concerted and participatory assessment, problem solving, and related activities and processes.

### CROSS-REFERENCE TO RELATED APPLICATIONS

This non-provisional patent application claims the benefit of priority of a United States (US) provisional patent application titled, “Extendable information management mechanism for organizing stakeholders, objectives, efforts, metrics, analyses, and more” (typos corrected from provisional submission cover sheets), sent to the Patent Office on Aug. 25, 2011, by Randall Cherry at the US Environmental Protection Agency (US EPA) with No. 61/575,673. The sole inventor and writer of both patent applications (provisional and this non-provisional), Charles Richard Ziegler Jr., works at the US EPA, and on Aug. 22, 2012, Ziegler and the US EPA fully executed an agreement by which US EPA transferred and assigned patent rights to Ziegler, which US EPA thought necessary for Ziegler to submit this non-provisional patent without US EPA involvement. This non-provisional patent application is filed by Ziegler, outside of his role as an employee of the US EPA.

There are no additional cross-references.

### STATEMENT REGARDING FEDERALLY SPONSORED RESEARCH OR DEVELOPMENT

### If Applicable

The inventive concept described herein was conceived by the inventor, Charles Richard Ziegler Jr., outside of contractor-related federal sponsorship and outside of Ziegler's role as an employee of the US EPA, but during the time that Ziegler was considered an employee of the US EPA. Ziegler chose to make his employer, US EPA, aware of the inventive concept, so that US EPA might help Ziegler move the invention forward (for example, in the context of helping to file patents). Also see above section “Cross-reference to related applications.”

### REFERENCE TO SEQUENCE LISTING, A TABLE, OR A COMPUTER PROGRAM LISTING COMPACT DISC APPENDIX

Not Applicable

### BACKGROUND OF THE INVENTION

Online, computer-based systems and mechanisms that facilitate social (and/or community) and content networks are known. Existing online social media and/or social network mechanisms, such as Facebook, Goodreads, LinkedIn, and Myspace allow users to generate their own content, interact with others and content derived by others, and participate in other activities with other users. Content networks, for example, might be said to help organize information and other content (e.g. files, code, metadata, text, images) being shared across social networks. Social media and social networks add value to social interaction by way of online technology. Existing social media and social network mechanisms have made strides in areas related to, for example, social interacting through networking, blogging, marketing individual skills as part of individual career enhancement efforts, and crowdsourcing of information. However, social media, social networks, other information technology advancements (e.g., cloud computing and web services), and related cultural shifts (including globalization and growing cultural acceptance and use of online social media) could be better harnessed to improve assessment, problem organization, problem conceptualization, and problem solving—especially in the context of earth science, human health, and human behavioral challenges and in the context of engaging all appropriate stakeholders in any given problem-solving process or activity, focused at both individual and collective levels. Some social media websites allow users to define earth science-related topics and share those descriptions (e.g., Wikipedia allows users to collectively define “soil contamination”), but do not—along with other efforts related to the embodiment of the inventive concept described herein—offer a specific framework that: 1) organizes stakeholders, objectives, efforts, metrics, and analyses in the context of earth and human challenges, objectives, problems, and problem solving, 2) utilizes advancements in information technology including, but not limited to, social media, open source code, crowdsourcing, web services, and cloud computing, 3) is designed to be functionally extendable by its own participants, 4) is designed to be self-sustaining to the extent possible and to evolve with the changing information technology landscape, 5) is functionally and culturally aligned to help solve humanity's problems, among other alignments, as opposed to being focused on, for example, socialization and marketing, 6) focuses attention at a collective level (as opposed to individual level—primarily, wholly, or focally) for the purposes of assessment and problem solving, and manifest through social and content network characteristics such as relationships and interactions, and 7) allows interaction among all appropriate stakeholders (including, but not limited to individuals and groups) in an appropriately moderated and unified online environment. As such, the embodiment of the inventive concept described herein purports to do just that via an innovative approach to using, for example, social media, social networking, open source code, crowdsourced code, web services, cloud computing technology, and extendable information management technology, by way of an appropriately aligned business model.

### BRIEF SUMMARY OF THE INVENTION

The embodiment of the inventive concept generally relates to a system and method for managing online information and flow of such information among and between stakeholders and other content sources, in a computer-based environment. A goal of the embodiment of the inventive concept is to direct, create, and/or facilitate use of a knowledge sharing and collaborative platform, in the form of a website, websites, and/or online mechanisms, for individuals and groups to engage in concerted and participatory assessment and problem solving activities. The embodiment of the inventive concept aims to leverage, for example, online social media/networking, visualization, and data sharing technologies and associated online culture. The embodiment of the inventive concept includes, but is not limited to, the following characteristics: it is an online and/or networked, information-sharing, collaborative system, method, and/or mechanism (or combination of systems, methods, and/or mechanisms), manifest through computer-based interactive interfaces, databases and networks, that enables stakeholders to view, follow, engage, and contribute in concerted and/or participatory topic and problem identification and conceptualization, objective and goal setting, organization of information and interactions, challenge and problem tracking, problem solving, scenario planning, extension and improvement of the embodiment of the inventive concept itself, and related actions and analyses. The practice of assessing situations and/or solving problems may take many forms, whether ad hoc, formal, and/or some combination thereof; as such, the embodiment of the inventive concept provides a method whereby stakeholders can participate in related actions (e.g. identifying and framing problems, determining goals and/or objectives, defining and prioritizing options, acting, and assessing efforts), for example. An aspect of the inventive concept includes a computer-implemented method of managing information provided by an interface or several interfaces between one or more social networks of stakeholders and one or more content networks. Said interface or interfaces may take several forms and evolve over time. For purposes herein, stakeholders are broadly defined to include, but not be limited to: users of the embodiment of the inventive concept (e.g. individuals and organizations), content contributors, moderators, supporters (involuntary and voluntary), developers, programmers (of models, interfaces, etc.), and inventors. The examples described herein focus on earth science, human health, and human behavioral issues. Engaging stakeholders in participatory, collective, and online problem solving around those foci is a primary proposed focus of the embodiment of the inventive concept; however, the embodiment of the inventive concept could be beneficial in other ways and in other areas where assessment and problem solving may be appropriate. The embodiment of the inventive concept harnesses, for example, social media, open source code, crowdsourcing, web services, cloud computing technology, and extendable information management technology. The embodiment of the inventive concept is referred to herein as the Extendable Information Platform or EIP.

EIP helps to solve problems stated above in the background section, among other problems. For example, EIP harnesses the advantages and functions of social media, social networks, other information technology advancements (e.g. cloud computing and web services), and related cultural shifts (including globalization and growing cultural acceptance and use of online social media) to improve problem organization, conceptualization, and solving—especially in the context of Earth issues, human health, and human behavioral challenges, and in the context of engaging all appropriate stakeholders in any given related problem-solving process or activity. Unlike existing mechanisms that share some similarities (e.g. social networking characteristics and related online mechanisms such as Facebook) with EIP, EIP establishes a framework that: 1) organizes stakeholders, objectives, efforts, metrics, and analyses in the context of earth and human challenges, objectives, problems, and problem solving, 2) utilizes advancements in information technology including, but not limited to, social media, open source code, crowdsourcing, web services, and cloud computing, 3) is designed to be functionally extendable by its own participants, 4) is designed to be self-sustaining to the extent possible and to evolve with the changing information technology landscape, 5) is functionally and culturally aligned to help solve humanity's problems, among other alignments, as opposed to being focused on, for example, socialization and marketing, 6) focuses attention at a collective level (as opposed to, but not excluding, the individual level and/or individual purposes—primarily, wholly, or focally—which is common among existing social media websites) for the purposes of assessment and problem solving, and manifest through social and content network characteristics such as relationships and interactions, and 7) allows interaction among all appropriate stakeholders (including, but not limited to individuals and groups) in an appropriately moderated and unified online environment.

### BRIEF DESCRIPTION OF THE SEVERAL VIEWS OF THE DRAWING

The accompanying drawings illustrate example embodiments of this inventive concept and depict the above- and below-mentioned and other features of this inventive concept and the manner of attaining them. The drawings are described as follows:

FIG. 1 Example cyclic assessment and problem solving process.

FIG. 2 Example visualization made possible by the embodiment of the inventive concept, whereby benefits of displaying information from multiple sources, with varying levels of objectivity and/or subjectivity, in one place, are realized.

FIG. 3 Example illustration of how information might be visually organized as part of EIP to help stakeholders understand who is working on what in any given assessment, problem solving and/or similar activity or process.

FIG. 4 Example internal and external components of EIP, illustrated at a summary level abstraction of basic EIP composition; for example, human entities involved in this effort include stakeholders and EIP moderators.

FIG. 5 Example node relationships, describing relationships between various EIP nodes and examples of how those relationships might be manifest with contributed material.

FIG. 6 Example node relationships and uses, continued, describing relationships between and among various EIP nodes and examples of how those relationships might be manifest with contributed material.

FIG. 7 Example possible EIP social and content network architecture showing connections among node instances.

FIG. 8 Potential and example service-oriented architecture of EIP.

### DETAILED DESCRIPTION OF THE INVENTION

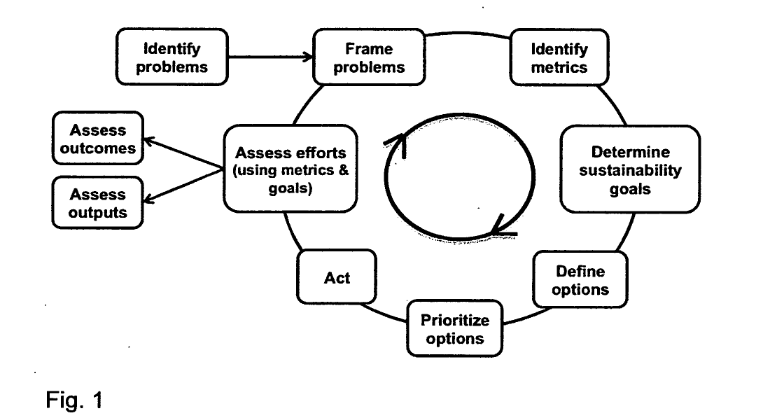

Various features, variations, and modifications to the following detailed description of the embodiment of the inventive concept and example embodiments of the inventive concept provided by the drawings can be included or excluded based upon particular use or uses. The embodiment of the inventive concept includes, but is not limited to, the following characteristics: it is an online and/or networked, information-sharing, collaborative system, method, and/or mechanism (or combination of systems, methods, and/or mechanisms), manifest through computer-based interactive interfaces, databases and networks, that enables stakeholders to view, follow, engage, and contribute in concerted and/or participatory topic and problem identification and conceptualization, objective and goal setting, organization of information and interactions, challenge and problem tracking, problem solving, scenario planning, extension and improvement of the embodiment of the inventive concept itself, and related actions and analyses. The practice of assessing situations and/or solving problems may take many forms, whether ad hoc, formal, and/or some combination thereof; as such, the embodiment of the inventive concept provides a method and related mechanisms whereby stakeholders can participate in related actions (e.g. identifying and framing problems, determining goals and/or objectives, defining and prioritizing options, acting, and assessing efforts) illustrated by example in FIG. 1. The embodiment of the inventive concept may be used to assist in other assessment and problem solving related tasks not shown in FIG. 1. An aspect of the inventive concept includes a computer-implemented method of managing information provided by an interface or several interfaces between one or more social networks of stakeholders and one or more content networks. Said interface or interfaces may take several forms and evolve over time. For purposes herein, stakeholders are broadly defined to include, but not be limited to: users of the embodiment of the inventive concept (e.g. individuals and organizations), content contributors, moderators, supporters (involuntary and voluntary), developers, programmers (of models, interfaces, etc.), and inventors. The examples described herein focus on earth science, human health, and human behavioral issues. Engaging stakeholders in participatory, collective, and online problem solving around those foci is a primary proposed focus of the embodiment of the inventive concept; however, the embodiment of the inventive concept could be beneficial in other ways and in other areas where assessment and problem solving may be appropriate. The embodiment of the inventive concept harnesses, for example, social media, open source code, crowdsourcing, web services, cloud computing technology, and extendable information management technology. The embodiment of the inventive concept is referred to herein as the Extendable Information Platform or EIP.

EIP helps to solve problems stated above in the background section, among other problems. For example, EIP harnesses the advantages and functions of social media, social networks, other information technology advancements (e.g. cloud computing and web services), and related cultural shifts (including globalization and growing cultural acceptance and use of online social media) to improve problem organization, conceptualization, and solving—especially in the context of Earth issues, human health, and human behavioral challenges, and in the context of engaging all appropriate stakeholders in any given related problem-solving process or activity. Unlike existing mechanisms that share some similarities (e.g. social networking characteristics and related online mechanisms such as Facebook) with EIP, EIP establishes a framework that: 1) organizes stakeholders, objectives, efforts, metrics, and analyses in the context of earth and human challenges, objectives, problems, and problem solving, 2) utilizes advancements in information technology including, but not limited to, social media, open source code, crowdsourcing, web services, and cloud computing, 3) is designed to be functionally extendable by its own participants, 4) is designed to be self-sustaining to the extent possible and to evolve with the changing information technology landscape, 5) is functionally and culturally aligned to help solve humanity's problems, among other alignments, as opposed to being focused on, for example, socialization and marketing, 6) focuses attention at a collective level (as opposed to, but not excluding, the individual level and/or individual purposes—primarily, wholly, or focally—which is common among existing social media websites) for the purposes of assessment and problem solving, and manifest through social and content network characteristics such as relationships and interactions, and 7) allows interaction among all appropriate stakeholders (including, but not limited to individuals and groups) in an appropriately moderated and unified online environment.

EIP allows stakeholders to engage in discussions surrounding, for example, Earth resources and sustainability goals. EIP provides an online space whereby decision support tools, models, methods, etc. may be combined and/or disseminated to and used by many stakeholders in an assessment and problem solving space and/or culture. Unlike some existing web-based decision support efforts, the social media/networking functionality of EIP allows, for example, users to connect group-specific and group-contributed profiles and objectives to analyses that can be viewed, discussed, and shared—for example—by, within and among stakeholders. EIP helps stakeholders engage in defining metrics of success and how stakeholder objectives can be contextualized and visualized in conjunction with those metrics. As stakeholders engage on topics, made possible by EIP, they are/may be more likely to engage in solving problems associated with those topics, and therefore attain desired outcomes and/or improve outcomes.

EIP will ultimately be available to anyone (with varying levels of access to information, based stakeholder-defined permissions), including, but not limited to, the public, social scientists, partnerships, and organizations that, for example, assess situations and solve problems. Multiple organizations attempt to solve the same and/or similar problems by different means, using different metrics and standards. EIP allows stakeholders to establish profiles, declare which problems and spatial scale(s) they work on, and visualize that information across other organizations—sort-able by stressor and/or topic area, for example. Visualization of this type of information may reduce duplicative efforts and foster synergy among those working to assess and/or solve the same or similar situations and/or problems, respectively. EIP provides collective areas for stakeholders to draft, for example, problem statements, ideas, objectives, challenges, and/or questions.

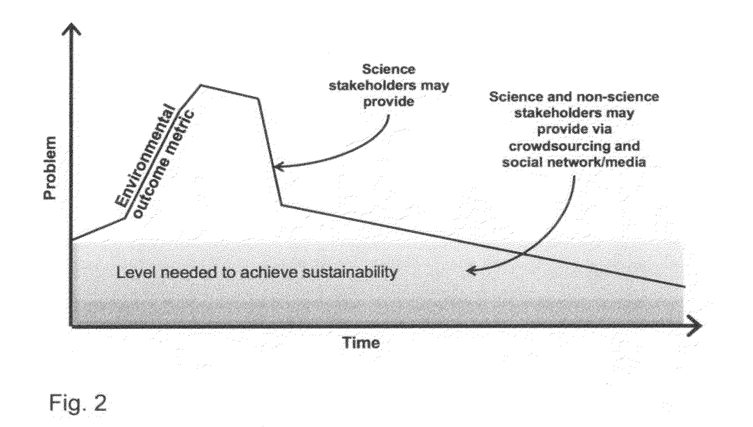

EIP allows stakeholders to identify geographic regions of interest (e.g., community boundaries) and work collaboratively online to visually depict and map relationships associated with assessments and/or problems (causal associations and/or decision trees) using, for example organizational charts and concept maps. Additionally, stakeholders are able to develop their own metrics by linking to data and customizable graphical display mechanisms (e.g. scatter plot, map, and advanced visualizations), as streaming data becomes more widely available from those stakeholders that collect, provide and/or produce data. EIP provides, for example, a means by which to integrate sustainability goals (e.g. place-based and community-defined sustainability) with, for example, metrics, such as environmental outcome metrics as a function of time, via embedded crowdsourcing and/or social media mechanisms/functionality, as illustrated by example in FIG. 2, allowing stakeholders to discuss, rank, vote on, and otherwise determine goals and then visually integrate those goals with metrics. Such capability allows for both objective (e.g. a metric or combination of metrics) and subjective information (e.g. objectives of stakeholders, individually or collectively) to be displayed together, whereby information sources are known/transparent to stakeholders. Referring to FIG. 2, by example illustration, EIP allows a diverse set of stakeholders (including for example, the public, government agencies, social scientists, earth system scientists, economists, non-profit organizations) to engage in an online and neutral location, where it is possible to combine and visualize information potentially previously not seen together, as part of a living dialog in assessing situations and solving problems. In the FIG. 2 example, a government agency might have interest in conveying an environmental outcome metric (e.g. a measureable trendline over time) to the public, but that agency might not have the authority, comfort, and/or data access for displaying another organization's data (e.g. cultural behavior) alongside its own; yet, that combination of information can be valuable and inform why or why not the trendline is changing over time. Further, neither aforementioned organization may necessarily have the authority and/or efficient ability to query and/or convey public opinion or goals (e.g. desired level needed to achieve sustainability, as defined by stakeholders) alongside the aforementioned information, again adding value to the problem solving process.

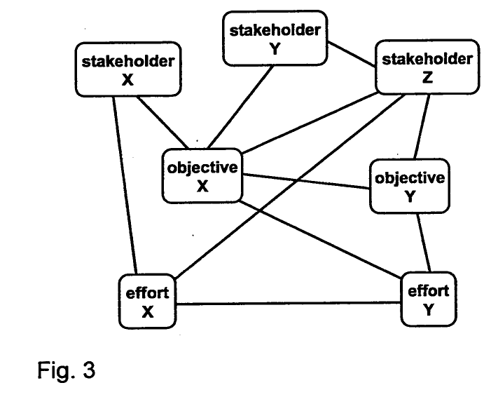

EIP facilitates production or stakeholder-generation of information, display of information from a variety of sources as appropriate (e.g. information from publicly available online databases), organization of information and information interactions, and generation of, or connection to, new EIP functionality (e.g. modular code that extends platform functionality to assist stakeholders with scenario planning). Information may more specifically include, but is not limited to, knowledge, evidence, data, stakeholder characteristics, problem statements and topic areas, questions, challenges, objectives, efforts, and resources. EIP will be available to anyone, including the public, social scientists, academia, governments, countries, individuals, and organizations. Some organizations share objectives and attempt to solve the same problems by different means, using different metrics to measure success or lack thereof. EIP allows users (organizations and/or individuals) to declare, for example, which problems and spatial scales they work on and to visualize who is working on which problems—which is illustrated by example in FIG. 3—and at which spatial scale(s). EIP therefore allows stakeholders to know if there are other stakeholders working to solve the same or similar problems. EIP may prevent duplicative efforts and foster synergy among those that share objectives or similar objectives. EIP embraces user-friendly heuristics, an intuitive modular design, and continues to evolve, so as to be understood and useable by as many stakeholders as possible and appropriate. EIP provides functionality to foster transparency to the extent possible and appropriate, in terms of, for example, making origin of information and decision-making processes transparent.

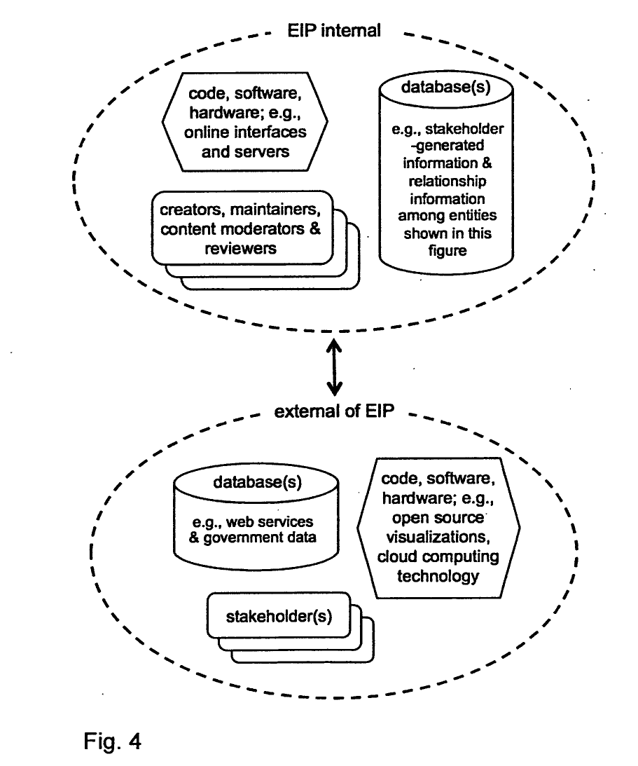

EIP includes a combination of components, illustrated by example in FIG. 4, aimed at providing online visualization (e.g. text and graphics), analysis, survey and other functionality for individual and collective use. For example, text functionality provides the ability for EIP users to draft problem statements, ideas, challenges, future scenarios, and/or questions. EIP users may work collaboratively to visually depict or map interactions (causal associations and decision tree) using, for example organizational chart and/or concept map mechanisms. Additionally, EIP users are able to develop their own metrics by linking to data and customizable graphical display mechanisms (e.g. scatter plot, map, and/or more advanced visualizations). EIP provides a framework for users to discuss, rank, vote on, and otherwise determine goals and objectives. EIP provides a framework to visually integrate goals with metrics (FIG. 2). EIP is flexible and extendable, and designed to evolve with user needs, technological advancements, and cultural changes over time.

A primary focus of EIP is transitioning components of earth systems science and human health and behavior problems, challenges, issues, assessments, and problem solving processes into a highly interactive, living, multi-lateral, participatory, and social experience and workspace. One potential configuration of EIP—to manifest that transition, recognizing that configurations will evolve over time—focuses on several types of content. These content types, rallying points, or foci are herein referred to as nodes. Nodes allow users and/or developers, among other interested parties, of EIP to understand how EIP [and particularly, its online interface(s)] are configured and allow stakeholders to rally behind any given node or stakeholder-generated content specific to a node. An example of EIP node-contributed content, specifically content that would be part of EIP's stakeholder node (see more below), might be compared to a common focus or rallying point found on social media websites—that is, the user profile. Nodes provide a helpful mechanism for compartmentalizing information so that humans can talk about and understand the information; however, EIP allows stakeholders to mix and match information within, between, and among the various nodes so as to achieve value from the information, as desired by stakeholders.

EIP may include, but will not be limited to, the following nodes: 1) stakeholder, 2) objective, 3) metric, 4) effort, and 5) association.

The stakeholder node allows for EIP to organize multiple types of stakeholders, including, but not limited to: individuals, organizations, groups of individuals, groups of organizations, groups of individuals and organizations, and groups of groups. Also, for example, there may be sub-organizations (another type of stakeholder) within any given organization or organizations. The stakeholder node may be programmed (web developed and/or computer coded) as several nodes (e.g., individual stakeholder node, organization stakeholder node, etc.) combined with pre-defined and stakeholder-defined relationships among and between stakeholders and stakeholder content. For example, an individual stakeholder may provide an instance of herself (e.g., her characteristics, description, and/or profile) within the stakeholder individual node, describing herself as an environmental scientist and an employee of (relationship) a specific organization (another stakeholder), existing as an instance of the stakeholder organization node; said individual stakeholder may or may not be an appropriate representative of her employer (this necessitates specific relationships and permissions, which may be situation and content-specific). EIP may allow said individual to have one or more separate instances of her stakeholder node; for example, one that is considered her public facing node instance, and one that is linked to her professional representation of her employer organization. EIP may also allow this distinction to be the responsibility of the individual stakeholder while generating content or interacting on the EIP. That is, EIP may provide functionality that allows stakeholders to clarify and/or track whether information is specific to an individual, organization, some other stakeholder, or combination thereof. In that sense, EIP has complex and extendable relationship—building and—setting functionality, some of which is now common in online social media and social networks. EIP relationship functionality may be integrated with node functionality, and provide EIP with, for example, the means and grounds by which to engage a variety of stakeholders (e.g., government employees and the public) in activities and discussions that they otherwise might not interact with each other on. EIP allows for creation of new relationships (and associated roles and rules), so as to anticipate and allow for new types of relationships. It is important to note that users of EIP may not necessarily log in to EIP and/or create an instance of the stakeholder node (e.g., by characterizing themselves) to benefit from EIP; stakeholders might also be unauthenticated and/or anonymous, and may nevertheless benefit from EIP, though may not necessarily contribute and engage at the same levels (and/or on the same activities) of authenticated and/or non-anonymous stakeholders.

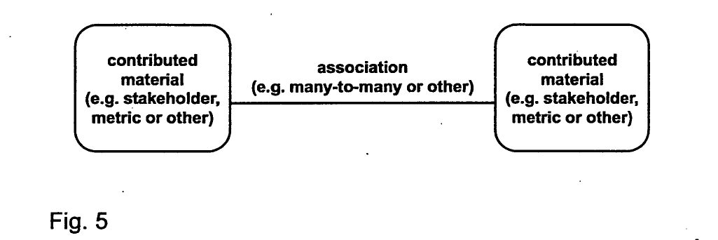

The objective node allows stakeholders to declare objectives, illustrated by example in FIG. 5. For purposes herein, an objective is broadly defined to include a goal, question, challenge, problem, similar, and/or more than one or combinations thereof. As EIP evolves through time, it may be appropriate to rename the objective node, or create more specific nodes to cover sub-components of this broad objective definition. Minimally and initially, the objective node provides functionality for stakeholders to characterize and/or connect or associate topics, realms, and value-based information with an instance of an objective node. For example, a stakeholder may have the objective of making high quality drinking water available to all humans living in City X. In that example, the topic might be considered drinking water and the realm considered City X, defined by a spatial boundary; those two characteristics might be considered the focus of the objective, whereas the value-based information might be considered more implicit. Namely, not all stakeholders will agree on what defines “high quality” and “available” in terms of drinking water; among other issues, there may be differences among stakeholders with respect to drinking water taste preferences, acceptable levels of contamination and/or risk, and availability for watering yards at different times of the day. It might be that stakeholders want to reduce contamination below a threshold or achieve sustainable water consumption. The EIP facilitates—among other functions—interpretation, discussion, and/or consensus building between and among stakeholders, in the context of objectives, by harnessing social media mechanisms (e.g. discussion, ideation, and ranking tools).

The metric node allows, for example, stakeholders to gauge success and/or failure of stakeholders and/or efforts in attaining objectives. The metric node allows EIP users to understand conditions and trends as a function of time, with and/or without any connection or perceived connection to stakeholder involvement and/or efforts. For example, an expression of the metric node might be contributed by a stakeholder with interest in drinking water issues within City X. The stakeholder may use the metric node to describe reasoning, approach, and necessary underlying data behind the development of a given metric. If said data exist and are attainable and available by EIP, then EIP will provide said stakeholder with a framework for linking the data to a display to show the metric, and in this case that metric might show a relationship (e.g. graphical display of a trendline) of how the quantity of a specific contaminant found in drinking water is changing over time, relying on water quality monitoring data. The metric node and related code essentially allow users to develop and build their own metrics that can be linked to stakeholder instances online and displayed as a living graphical indication of stakeholder instance conditions, or similar.

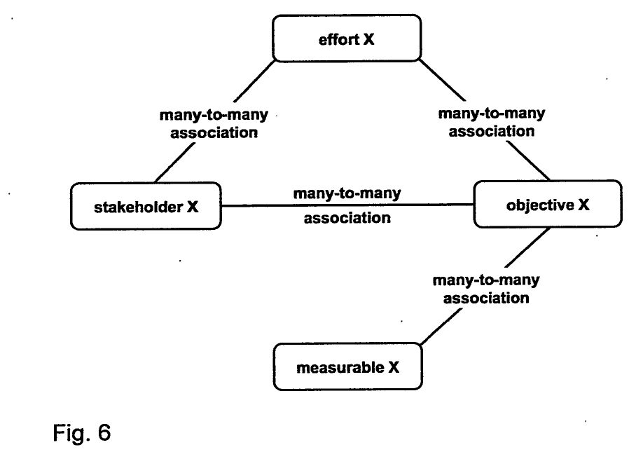

The effort node allows stakeholders to declare how they are attempting to meet objectives, as illustrated by example in FIG. 6. Stakeholders might use the effort node to describe, for example: 1) an approach, project, and/or program being undertaken to meet one or more objectives, 2) resources invested or planned for investment (e.g. money and personnel), 3) programmatic descriptions and characteristics (e.g., grant programs), and 4) legal mandates and/or regulations. Stakeholder relationships and permissions are an important component of EIP in terms of the effort node. For example, a stakeholder may want to share information publicly about a programmatic effort and related approach to reduce contamination in drinking water (perhaps as part of an open government/transparency initiative), but only share details about resources invested—and/or proposed for investment—in that effort within and among a specific set of stakeholders.

The association node allows stakeholders to understand, display, develop, and/or contribute to the inter-relationships or hypothesized relationships between and among issues related to EIP and its content. For example, EIP stakeholders may wish to understand and visually depict how a specific organization (another stakeholder) is hierarchically structured and how that hierarchy supports that organization's attempts and/or efforts related to achieving objectives. This and other EIP association-based information may be displayed using organizational charts, concept maps, or similar visual tools. Essentially, EIP allows users to develop graphical representations of inter-relationships of information, such as organizational charts (FIG. 3 might be considered an example of an organizational chart graphic, similar to something an EIP user might want to develop and link to any given node instance). Another example of association-based information contributed by stakeholders could be the associations involved in how drinking water becomes contaminated. For this example, stakeholders may wish to use frameworks developed to organize triples (subject, predicate, and object, or object, attribute, and value associative relationships), pressure, state, and response (PSR) information, driving forces, pressures, states, impacts, and responses (DPSIR) information, or some other user-chosen framework. As such, stakeholders may edit the information within such a framework (and within one or more user-generated expressions of information using the association node) to describe how, for example, increased industrial activity in watersheds within City X leads to increased contamination of streams, which leads to increased contamination of drinking water sources (e.g. groundwater, reservoirs, or other), which leads to increased contamination of tap water in homes of humans living in City X, which may lead to increased human health problems, etc., etc. Another example of association-based information contributed by stakeholders might be decision support and/or influence diagrams, geared toward visually depicting decision analysis and/or scenario planning, whereby stakeholders attempt to collectively identify strategies most likely to increase chances of attaining objectives.

The association node might be used by stakeholders as a standalone node, or might support other nodes. For example, one or more uses of the association node to characterize PSR or DPSIR associations related to drinking water sustainability on Earth might be of general interest to water scientists, outside the context of information from other nodes, for example, efforts, objectives, and metrics. The association node may also, for example, support other nodes by organizing information specific to one or more nodes, such as described earlier in this node description, in the context of a hierarchically structured stakeholder or cluster of interrelated stakeholders. The association node may also, for example, support relationship associations as part of the stakeholder node, and within or among any given node or combination of nodes.

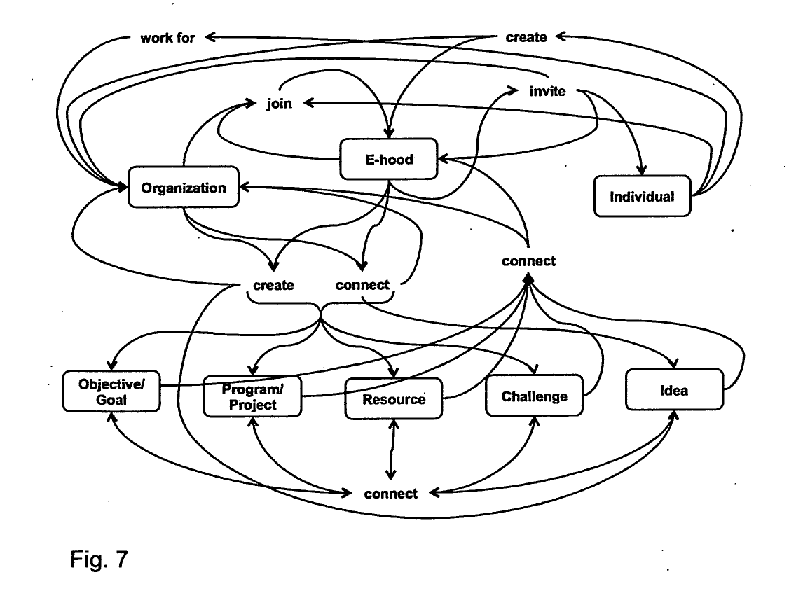

EIP databases and database tables may be established for various nodes and node types, and their related instances. Information may be displayed and ordered by way of connections among nodes and instances of nodes. FIG. 7 provides one possible EIP social and content network architecture showing connections among node instances.

Existing decision support methods and tools often lay out a step-wise and/or static approach to, for example, solving problems or moving toward sustainability. Some stakeholders may subscribe to a linear approach in their use of the nodes described herein—that is, a stakeholder may want to start by defining who they are, by using the stakeholder node, then identifying objectives, then assessing associations among issues surrounding the topic areas of the objectives, then declaring metrics by which to measure or gauge success, and then outlining efforts for achieving objectives. Some stakeholders may subscribe to a cyclic approach (see example cyclic approach in FIG. 1) by, for example, constantly readjusting or revisiting efforts based on feedback from other nodes, such as the metrics node. Some stakeholders may also decide to use just one node and nothing else.

EIP will be developed to assist with static, linear, cyclic, and/or single node approaches, but a strength of EIP will be its ability to adapt to stakeholder needs through an object-oriented philosophy and foundation, not necessarily relying on linear, cyclic, or single node processes. EIP, as such, attempts to divvy up information—and impart understanding of information to stakeholders—using the lowest appropriate common denominator of any given content, and thereby allow for extension from that point based on stakeholder needs. For example, a metric might consist of several components, including code to graphically display the metric, data from multiple sources, and stakeholder-generated information to link the data into the display; EIP allows the display mechanism to be chosen and used for multiple purposes and/or analyses. Another example resides with content, in the sense that, for example, one metric may be used by many different stakeholders for many different reasons. As such, EIP code and content are modular, flexible, and object-oriented.

EIP allows appropriate stakeholders appropriate levels of engagement and interaction. As described earlier in the stakeholder node examples, EIP provides functionality that allows individuals, organizations, and individuals who are part of organizations a variety of permissions and roles (and the ability to create and/or combine new permissions and/or roles) so that all stakeholders can add material and value to EIP, as appropriate. EIP harnesses the power of self-policing mechanisms (similar to Wikipedia, e.g.), but also provides more explicit and direct peer review functionality, depending on content and stakeholder needs. For example, the EIP environment allows stakeholders to identify reviewers of contributed material and code and to create queues or workflows by which material and code might move through before receiving certain approvals, validation, and/or status (e.g. draft, beta, final). EIP provides functionality whereby stakeholders can attach non-anonymous authorship information to contributions. EIP is neutral and transparent to the extent possible and appropriate. Moderation of EIP is not biased by economic and political forces, to the extent possible. Governance and moderation is set up and shall evolve based on a philosophy of neutrality. As such and for example, an EIP board of directors, consortium(s), non-profit(s), and/or similar may be used and/or set up to moderate EIP operations, put self-sustaining moderation mechanisms in place, and/or ensure neutrality.

Nodes and instances of nodes might represent focal points within the EIP online interface. For example, stakeholders may visualize an instance of the stakeholder node as a profile of an individual with their picture, characteristics, metadata, and links to objectives of interest connected to that particular stakeholder. To visualize what part of EIP might look like to any given user through an online desktop browser, one might think of Facebook's profile page layout of information as displayed on an online desktop browser interface (as of Aug. 23, 2011). Facebook has profile-specific information in the top left corner of the screen, as may EIP for stakeholder node instances. Where Facebook displays “wall” posts within the center column of an interface, EIP might display information specific to current or recent events and/or information related to a stakeholder or objective instance, for example, or some other node instance. For example, there could be a metric graphic or DPSIR concept map shown in the “wall” post area, as opposed to the “wall” posts, and that graphic or concept map would be linked to one or more stakeholder instances and streaming data from web services. The right side of the Facebook profile page shows things that might be related to the user profile; EIP's right side might show other stakeholder instances that share objectives or metrics, or the right side might show information and/or metadata specific to the stakeholder that is logged in to EIP, for example. EIP information displays and layouts will be flexible; the above potential layout description is provided as an example.

EIP is, and will evolve using, open source, freely-available, extendable, flexible, and/or extensible technology—to the extent possible and appropriate. Some resources and software appropriate to comprise and/or further develop EIP exist. For example, it may be appropriate to use an existing open source content management system (CMS) or platform such as Drupal (www.drupal.org) to develop the core functionality and/or interface of EIP. Third party entities (e.g. companies, programmers, and web developers) contribute to and maintain modular Drupal code, thereby continually updating and extending potential functionality of Drupal sites. EIP is designed to take advantage of ongoing improvement and extension of free and open source functionality, and may be designed to take advantage of modularity similar to, and/or contributions of, Drupal and/or similar CMSs. Other support, resources, and/or functionality may come from other sources, such as Google code, http://code.google.com/apis/chart/, and Provotis' visualizations, http://vis.stanford.edu/protovis/. EIP may connect to and use decision support mechanisms and tools developed by others and designed to be modular

EIP is designed to be extendable and improvable. New and/or improved functionality may be developed and integrated as new nodes and/or developed as modules to be integrated into existing nodes, integrated as other content types (e.g. analytical or visual tools) and may support one or more nodes described above, or standalone. For example, stakeholders with expertise in web development may create EIP code in the form of, for example, improved stakeholder node profile tools or interfaces, ideation modules, social science and economic modules that allow stakeholders to conduct willingness to pay surveys, data solicitation modules, grant tracking modules, emissions trading modules (see below), organization and portfolio management modules, effort timeline modules that allow stakeholders to better visualize progress as related to efforts and metrics, scenario planning modules, urban and building design modules, apportionment visual tools so that stakeholders can see what impact (or lack of impact) different stakeholders and their efforts are having on different metrics, and calendar and Gantt chart modules that allow stakeholders to manage efforts. EIP is designed to mushroom, in terms of how it's used and the stakeholders that use it; the examples and initial functionality (primarily described in terms of nodes above) described herein do not comprise the scope of EIP. Rather, EIP is designed to grow and evolve.

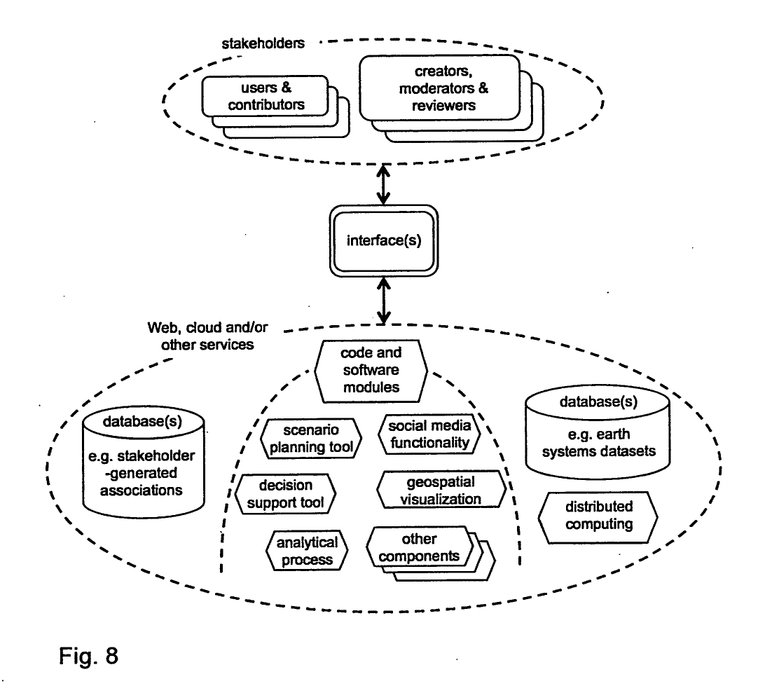

EIP subscribes to linked open data, software services, and cloud computing philosophies and actions, as illustrated by example in FIG. 8, until and unless more appropriate and/or better philosophies are discovered and/or emerge (those will then be embraced). Specifically, and for example, EIP may connect to web service data providers (and/or linked open data), thereby allowing EIP stakeholders to use data (and create content) without having that data stored on EIP-specific databases and/or servers. As cloud-computing functionality becomes more widespread and available, EIP may make use of that technology, allowing computations and other exercises in the cloud, as opposed to within, for example, EIP's server environment. EIP has code and database tables of its own, among other components. Web service providers, software developers, software providers and maintainers, cloud computing organizations, and similar entities will and may become EIP stakeholders themselves. It is anticipated that all EIP-related data and code or software may one day be stored, supplied, and delivered via web services, and computations conducted in the cloud as part of the EIP platform. In the interim, EIP is designed with core code or software as needed, to facilitate data upload and download as necessary, and to conduct computations within the EIP server environment to the extent needed. EIP may provide functionality whereby stakeholders can solicit new web services [and associated data]; for example, if enough EIP stakeholders request that a specific government agency places its data into a web services environment, and those stakeholders demonstrate the value of doing so, the agency may be more likely to meet the request. Note that, in that example, the actual data might not be stored on an EIP database; rather EIP is acting to catalyze, and eventually take advantage of, web services.

Some EIP stakeholders are developers and data providers. That is, for example, stakeholders are able to supply data, links to data web services, modular code, and programming that can be utilized in the EIP environment. Just as third party programmers develop code for Drupal (CMS mentioned earlier), for example, EIP stakeholders are able to develop additional functionality or improvements to EIP.

EIP is designed as, and may continue to evolve into, a self-sustaining entity to the extent possible and appropriate. Stakeholders developing code, content contributors, philanthropists, content reviewers, etc., may choose to support EIP with or without monetary compensation from EIP, and EIP may receive additional revenue through other avenues, such as licensing. Evolution and moderation of the EIP site, staff, and servers, for example, may require dollar resources. EIP may develop, adopt and/or take advantage of one or more revenue streams. For example, advertising, subscription, and/or fee-for-use may be used by EIP, as appropriate, to generate revenue. For example, stakeholders using EIP to market themselves or to make money may be using EIP appropriately and for its intended purposes, and may be subject to paying toward and/or through EIP (and its stewards, moderators, staff, e.g.) in fees or similar. Parties using concepts individually or as a whole, described herein, may be required to pay licensing or other fees to the inventors and/or moderators of EIP.

EIP is designed to facilitate trades and other exchanges among and between stakeholders. For example, third party developers may want compensation if their contributed data and/or code are used for certain purposes and/or by certain stakeholders. For example, Google develops code that can be used modularly in CMS's like Drupal, but some organizations are required by Google to pay for certain uses of Google code. EIP may be designed to track similar such usage as necessary. Another example of a potential exchange being facilitated by way of EIP is request or challenge-based. For example, a stakeholder may request data or modular functionality, and may post a prize or similar for another stakeholder that supplies a solution (or the best solution) to the request. Another EIP-facilitated trade example may be emissions, pollutant, or similar trading; for example, EIP may allow stakeholders to trade carbon or nitrogen emissions. If money, resources, emissions credits, and/or similar changes hands by way of EIP, EIP stewards, caretakers, developers, staff, etc. may choose to collect, for example, a fee, transaction percentage, or subscription from those stakeholders involved.

What is claimed is:

1. A computer-implemented method, system, mechanism, and/or mechanisms for managing a network or networks of stakeholders, including both individuals and groups, and a network or networks of content, minimally aimed at focal areas fostering assessment, problem solving, and related activities and processes, extendible in scope, the method comprising:
creation of, and/or use of existing, stakeholder communities across network devices;
creation, storage, organization, and/or display of information from stakeholders and online sources; and
use of existing, present, and future information from stakeholders and other sources as related to assessment, problem solving, and related activities and processes.

2. A method of claim 1, wherein the embodiment of the inventive concept organizes and/or visually displays stakeholders, objectives, efforts, metrics, analyses, associations thereof, related characteristics and/or descriptions thereof, and other related information in the context of earth and human challenges, objectives, assessments, problems, problem solving, and other categories related to human endeavors.

3. A method of claim 1, wherein the embodiment of the inventive concept utilizes advancements in information technology including, but not limited to, social media, social networks, open source code, crowdsourcing, databases, servers, web services, and cloud computing.

4. A method of claim 1, wherein the embodiment of the inventive concept is functionally extendable and/or improvable by its own members, users, and/or participants and others either knowingly or unknowingly through, for example, use of participant-generated, freely available, and publicly available code and information.

5. A method of claim 1, wherein the embodiment of the inventive concept is self-sustaining and its framework politically neutral to the extent possible, to evolve with the changing information technology landscape and related cultures regardless of political change and cycles, for example, by using extendible and updateable online content management systems and user-friendly easily understood interfaces, interface designs, and visualization mechanisms.

6. A method of claim 1, wherein the embodiment of the inventive concept is functionally and culturally aligned to help assess and solve humanity's problems, among other alignments, both present and potentially defined by members, users, and/or participants of the embodiment of the inventive concept.

7. A method of claim 1, wherein the embodiment of the inventive concept focuses attention at a collective level (as opposed to individual level—primarily, wholly, or focally) for the purposes of assessment, problem solving, and related activities and processes, manifest through social and content network characteristics and functions such as relationship building and interactions, and allowing interaction among all appropriate stakeholders (including, but not limited to individuals and groups) in an appropriately moderated and unified online environment.

8. A method of claim 1, wherein the embodiment of the inventive concept is financially supported through interactions and activities of stakeholders.

9. A method of claim 4, wherein said users, members, and/or participants extend functionality of the embodiment of the inventive concept as part of their participation and interaction with the embodiment (e.g. computer and online-based interfaces) of the inventive concept, which can be further described by example whereby participants use the embodiment to solve problems individually or communally, which may include, for example, Earth resource problems and attempt to improve and/or extend the functionality of the embodiment itself, for example, by developing and connecting a new online graphical visualization tool for better displaying data about Earth resources.

10. A method of claim 4, wherein said users, members, and/or participants determine as appropriate—in conjunction with stewards and/or staff—moderation, rules, interactions, governance, and similar, for the embodiment of the inventive concept.

11. A method of claim 6, wherein areas of focus of the embodiment of the inventive concept include assessment and problem solving activities and processes related to humanity, which might include, but not be limited to, linear, cyclic, single step, and flexible object-oriented processes in subject areas where support might be needed such as Earth natural resource care and management and human behavior in areas related to, for example, tax, health care, economic, and political issues.
